(19) United States
(12) Patent Application Publication
(10) Pub. No.: US 2009/0162523 A1
(43) Pub. Date: Jun. 25, 2009

(54) GINSENG NUTRITIOUS INSTANT TEA AND PREPARATION METHOD THEREOF

(75) Inventor: Liying GENG, Beijing (CN)

Correspondence Address: YING CHEN;Chen Yoshimura LLP, 255 S. GRAND AVE., # 215, LOS ANGELES, CA, 90012, US

(73) Assignee: Beijing Aotengxunda Science and Technology Co., Ltd, Beijing (CN)

(21) Appl. No.: 11/964,018

(22) Filed: Dec. 25, 2007

(30) Foreign Application Priority Data
Dec. 24, 2007 (CN) 200710303964.3

(51) Int. Cl. A23F 3/34; A23F 3/18; A23F 3/28

(52) U.S. Cl. 426/597; 426/435

(57) ABSTRACT

The present invention relates to a ginseng nutritious instant tea comprising water-soluble active ingredients. The raw materials thereof mainly comprise tea, chrysanthemum and ginseng with a ratio: ginseng 10 parts, tea 80-120 parts, preferably 100-110 parts, chrysanthemums 60-100 parts, preferably 70-80 parts. The said tea is green tea and black tea also can be used. According to personal taste, other raw materials and additives can be added, such as citric acid and sugar, etc. The preparation method for such instant tea is to select and formulate the major raw materials according to a certain proportion. The preparation mode is to firstly extract the water-soluble active ingredients from these raw materials in the water, then to filter and concentrate the water extract of all kinds of raw materials, to mix and spray drying to form the instant tea powder. Such instant tea accords with people's drinking habits and tastes well, not only plays a role of eliminating thirsty and restoring consciousness as ordinary tea, but also has a good nourishing role, particularly fitting for the weak elderly and other people who is engaged in the brainwork for a long time.

### TECHNICAL FIELD

This invention relates to an instant tea with good nourishing role and the preparation method thereof.

### BACKGROUND

Tea is a common drink; especially the bagged instant tea is popular due to convenient to use. Because people often drink tea, they can get restorative by adding the nutritious ingredients to the tea. Especially in the autumn and winter or for the weak elderly, the corresponding active ingredients can be effectively ingested through drinking nutritious tea, improving the body health.

### SUMMARY

To overcome the shortcomings of existing technology, the present invention provides a ginseng nutritious instant tea, which not only plays a role of eliminating thirsty and restoring consciousness as ordinary tea, but also has a good nourishing role.

To achieve the above purpose, the technical solution in the present invention is that a ginseng nutritious instant tea comprises water-soluble active ingredients.

A preparation method for ginseng nutritious instant tea, characterized in that its main raw materials comprise tea, chrysanthemum and ginseng with the relative ratio between them: ginseng 10 weight parts, tea 80-120 weight parts, chrysanthemum 60-100 weight parts. The water-soluble active ingredients are firstly extracted from these raw materials in the water, and then the water extracts are filtered and concentrated to form the instant tea powder after spray-drying. Other raw materials can be mixed in the spray-drying materials liquid before spray-drying according to their respective nature.

The beneficial effect of the present invention is that as the water-soluble active ingredients of ginseng are added into the instant tea, they have a good nourishing role and are easily absorbed, making people obtain nutrition in drinking tea, helping to improve the level of health, particularly fitting to nourish the weak elderly, and according with the living habits of the elderly, not adding any burden, also having a good effect for other people engaged in the brainwork for a long time.

### DETAILED DESCRIPTION

While the claims are not limited to the illustrated embodiments, an appreciation of various aspects of the present invention is best gained through a discussion of various examples thereof. Referring now to the drawings, illustrative embodiments will be described in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description.

A ginseng nutritious instant tea comprises water-soluble active ingredients.

The raw materials of the instant tea mainly comprise tea, chrysanthemum and ginseng with a ratio: ginseng 10 parts (weight parts, the same below), tea 80-120 parts, preferably 100-110 parts, chrysanthemums 60-100 parts, preferably 70-80 parts.

The said tea is preferably green tea and black tea also can be used.

Other additives such as citric acid, sugar or active ingredients of raw materials can be added. Usually the raw materials dissoluble in water are selected which can be dissolved in water extraction of the main raw materials during the preparation process and granulated or dried (such as using spray-drying method). All the raw material components of the tea can be dissolved in water when making prepared tea in water.

A preparation method for ginseng nutritious instant tea, characterized in that its main raw material comprises tea, chrysanthemum and ginseng with the relative ratio between them according to the above ratio. One of the preferable schemes is ginseng 10 parts, tea 80-120 parts, preferably 100-110 parts, chrysanthemum 60-100 parts, preferably 70-80 parts. The preparation process is that the water-soluble active ingredients are firstly extracted from these raw materials in the water, and then the water extracts of all kinds of the raw materials are filtered and concentrated to form the instant tea powder after mixed and spray-drying. Other raw materials can be mixed in the spray-drying materials liquid before spray-drying according to their respective nature.

The mode of water extract for the tea is that the tea added eight times volume of water is extracted for 20-30 minutes at 75-85° C., and then added again six times volume of water it is extracted for 20-30 minutes at 75-85° C. The filtrate after two times extraction in the water is merged for store.

The mode of water extract for the chrysanthemums is that the chrysanthemums added eight times volume of water is extracted for 20-30 minutes at 80-90° C., and then added again six times volume of water it is extracted in hot water for5-10 minutes. The filtrate after two times extraction in the water is merged for store.

The mode of water extract for the ginseng is that the ginseng is sliced or broken, boiled for 6 hours after being added twenty times volume of water, filtered and obtained the first filtrate, then boiled for 4 hours after being added fifteen times volume of water again, filtered and obtained the second filtrate. The two-time filtrate is merged for store.

Some idiographic ratio of the raw materials as follows:

Example 1: Ginseng 10 kg, tea 80 kg, chrysanthemums 100 kg, a quantity of citric acid and sugar (determined according to the taste of consumers).

Example 2: Ginseng 10 kg, tea 120 kg, chrysanthemums 70 kg, a quantity of citric acid and sugar.

Example 3: Ginseng 10 kg, tea 100 kg, chrysanthemums 80 kg, a quantity of citric acid and sugar.

Example 4: Ginseng 10 kg, tea 110 kg, chrysanthemums 60 kg, a quantity of citric acid and sugar.

Example 5: Ginseng 10 kg, tea 105 kg, chrysanthemums 75 kg, a quantity of citric acid and sugar.

The foregoing description of various embodiments of the invention has been present for purpose of illustration and description. It is not intent to be exhaustive or to limit the invention to the precise embodiments disclosed. Numerous modifications or variations are possible in light of the above teachings. The embodiments discussed where chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A ginseng nutritious instant tea, wherein the tea comprises water-soluble active ingredients of the ginseng.

2. The ginseng nutritious instant tea as claimed in claim 1, wherein the tea is green tea or black tea.

3. The ginseng nutritious instant tea as claimed in claim 1, wherein further comprises citric acid.

4. The ginseng nutritious instant tea as claimed in claim 1, wherein further comprises sugar.

5. The ginseng nutritious instant tea as claimed in claim 1, wherein its raw materials mainly comprise tea, chrysanthemum and ginseng with the following ratio: ginseng 10 weight parts, tea 80-120 weight parts, chrysanthemum 60-100 weight parts.

6. The ginseng nutritious instant tea as claimed in claim 5, wherein the tea is green tea or black tea.

7. The ginseng nutritious instant tea as claimed in claim 1, wherein its raw materials mainly comprise tea, chrysanthemum and ginseng with the ratio: ginseng 10 weight parts, tea 100-110 weight parts, chrysanthemum 70-80 weight parts.

8. The ginseng nutritious instant tea as claimed in claim 7, wherein the tea is green tea or black tea.

9. A preparation method for the ginseng nutritious instant tea, wherein its raw materials mainly comprise tea, chrysanthemum and ginseng from which the water-soluble active ingredients are firstly extracted in the water, and then the water extracts are filtered, concentrated and spray drying to form the instant tea powder, and other raw materials can be mixed in the spray-drying raw materials liquid before the spray-drying according to their respective nature.

10. The ginseng nutritious instant tea as claimed in claim 9, wherein the tea is green tea or black tea.

11. The ginseng nutritious instant tea as claimed in claim 10, wherein the said other raw materials comprise citric acid.

12. The ginseng nutritious instant tea as claimed in claim 10, wherein the said other raw materials comprise sugar.

13. The ginseng nutritious instant tea as claimed in claim 9, wherein its raw materials mainly comprise tea, chrysanthemum and ginseng with the following ratio: ginseng 10 weight parts, tea 80-120 weight parts, chrysanthemum 60-100 weight parts.

14. The ginseng nutritious instant tea as claimed in claim 13, wherein the said other raw materials comprise citric acid and sugar.

15. The ginseng nutritious instant tea as claimed in claim 9, wherein its raw materials mainly comprise tea, chrysanthemum and ginseng with the following ratio: ginseng 10 weight parts, tea 100-110 weight parts, chrysanthemum 70-80 weight parts.

16. The ginseng nutritious instant tea as claimed in claim 15, wherein the said other raw materials comprise citric acid and sugar.

17. The preparation method for the ginseng nutritious instant tea as claimed in claim 9, wherein the mode of the water extract for the tea is that the tea added eight times volume of water is extracted for 20-30 minutes at 75-85° C., and then it added again six times volume of water is extracted for 20-30 minutes at 75-85° C., then the filtrate after two times extraction in the water is merged for store, and during the preparation process, other raw materials or their active ingredients and additives are added according to the nature of other raw materials and additives.

18. The preparation method for the ginseng nutritious instant tea as claimed in claim 9, wherein the mode of the water extract for the said chrysanthemum is that the chrysanthemum added eight times volume of water is extracted for 20-30 minutes at 80-90° C., and then it added again six times volume of water is extracted in hot water for 5-10 minutes, and the filtrate after two times extraction in the water is merged for store.

19. The preparation method for the ginseng nutritious instant tea as claimed in claim 9, wherein the mode of the water extract for the said ginseng is that the ginseng is sliced or broken, boiled for 6 hours after being added twenty times volume of water, filtered and obtained the first filtrate, then boiled for 4 hours after being added fifteen times volume of water again, and the second filtrate can be obtained by filtration and then the two-time filtrate is merged for store.
